(19) United States
(12) Patent Application Publication
(10) Pub. No.: US 2015/0093622 A1
(43) Pub. Date: Apr. 2, 2015

(54) BATTERY CASE

(71) Applicant: Samsung SDl Co., Ltd., Yongin-si (KR)

(72) Inventor: Kyung-Kyun LEE, Yongin-si (KR)

(21) Appl. No.: 14/504,089

(22) Filed: Oct. 1, 2014

(30) Foreign Application Priority Data
Oct. 2, 2013 (KR) 10-2013-0117780

(51) Int. Cl. H01M 2/10

(52) U.S. Cl. CPC H01M 2/105
USPC 429/99

(57) ABSTRACT

A battery case includes a first case and a second case. The first case has a first side portion surrounding an internal space thereof, and has a first fastening portion extended from an end portion of the first side portion. The second case has a second side portion corresponding to the first side portion, and has a second fastening portion fastened to the first fastening portion. In the battery case, the first fastening portion is bent to extend toward the internal space from the end portion of the side portion, and the second fastening portion is spaced apart from the second side portion inside the second case to extend toward the first fastening portion.

### RELATED APPLICATIONS

This application claims priority to and the benefit of Korean Patent Application No. 10-2013-0117780, filed on Oct. 2, 2013, in the Korean Intellectual Property Office, the entire contents of which are incorporated herein by reference in their entirety.

### BACKGROUND

1. Field

An aspect of the present invention relates to a battery case, and more particularly, to a battery case having improved productivity.

2. Description of the Related Technology

The shapes of secondary batteries can be freely changed depending on electronic devices in which the secondary batteries are employed. Since the secondary batteries can effectively accumulate energy as compared with their volume and mass, the secondary batteries are frequently used as power sources of portable electronic devices.

The shape of a battery case should be variously implemented according to the configuration of the secondary batteries and an electronic device in which the secondary batteries are employed. The battery case preferably has a configuration in which the safety of the secondary batteries can be maintained, and simultaneously, provides solidity and good aesthetics of its external appearance. Studies have been conducted in various fields to effectively produce such a battery case and to improve productivity by reducing failures.

### SUMMARY OF CERTAIN INVENTIVE ASPECTS

Embodiments provide a battery case fastened in a new manner.

Embodiments also provide a battery case which can improve the uniformity of its external appearance by preventing the occurrence of a stress mark.

According to an aspect of the present invention, there is provided a battery case, including: a first case having a first side portion with an end portion surrounding an internal space thereof, the first case having a first fastening portion extended from the end portion of the first side portion; and a second case having a second side portion corresponding to the first side portion, the second case having a second fastening portion fastened to the first fastening portion, wherein the first fastening portion is bent to extend toward the internal space from the end portion of the side portion, and the second fastening portion is spaced apart from the second side portion inside the second case to extend toward the first fastening portion.

The first fastening portion may include a plate extended from the end portion of the first side portion, wherein a fastening hole may be provided inside the plate.

The fastening hole may be provided to pass from a first surface of the plate facing the second side portion to a second surface that is the opposite surface of the first surface of the plate, and the size of the fastening hole provided in the first surface of the plate may be formed greater than that of the fastening hole provided in the second surface of the plate.

The second fastening portion may be fastened to the first fastening portion by being inserted into the fastening hole of the first fastening portion.

The second fastening portion may include an extending portion extended from an inside of the second side portion, and a fastening projection protruded from an end of the extending portion in the opposite direction to the second side portion.

The fastening projection may be inserted into the fastening hole, and may have a portion vertically connected to the extending portion.

A stepped portion recessed inward from an outer surface of the second side portion may be provided at an end of the second side portion.

An end of the stepped portion may be mounted on the plate.

The first case may include a first base portion and a first side portion connected to surround the internal space at the outer circumference of the first base portion, and the second case may include a second base portion configured to face the first base portion, and a second side portion extended from the outer circumference of the second base portion to face the first base portion. At least one portion of the first side portion may be connected to the first base portion to have a curved surface portion, and at least one portion of the second side portion may be connected to the second base portion to have a curved surface portion.

The second fastening portion may be provided perpendicular to the second base portion at the curved surface portion of the second side portion.

The second fastening portion and the second side portion may be integrally formed by injection, using one mold.

One or more ribs connecting the second fastening portion and the second side portion may be provided between the second fastening portion and the second side portion.

The rib may be provided perpendicular to the second fastening portion.

The first fastening portion may be further provided with a mounting portion on which the end of the second side portion is mounted.

The mounting portion may be provided in the first surface of the plate facing the second side portion, and may have surface roughness corresponding to that of the end of the second side portion.

As described above, according to the present invention, it is possible to provide a battery case fastened in a new manner.

Further, it is possible to provide a battery case which can improve the uniformity of its external appearance by preventing the occurrence of a stress mark.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view of a battery case according to an embodiment of the present invention.

FIG. 2 is an exploded perspective view of the battery case of FIG. 1.

FIG. 3 is an enlarged view of portion A of FIG. 2.

FIG. 4 is an enlarged view of portion B of FIG. 2.

FIG. 5A is a perspective sectional view taken along line I-I of FIG. 1.

FIG. 5B is a sectional view taken along line I-I of FIG. 1.

FIG. 6 is a sectional view showing a second fastening portion according to another embodiment of the present invention.

FIG. 7 is a perspective view showing a first fastening portion according to still another embodiment of the present invention.

FIG. 8 is a sectional view showing the first fastening portion and a second fastening portion according to the embodiment of the present invention.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

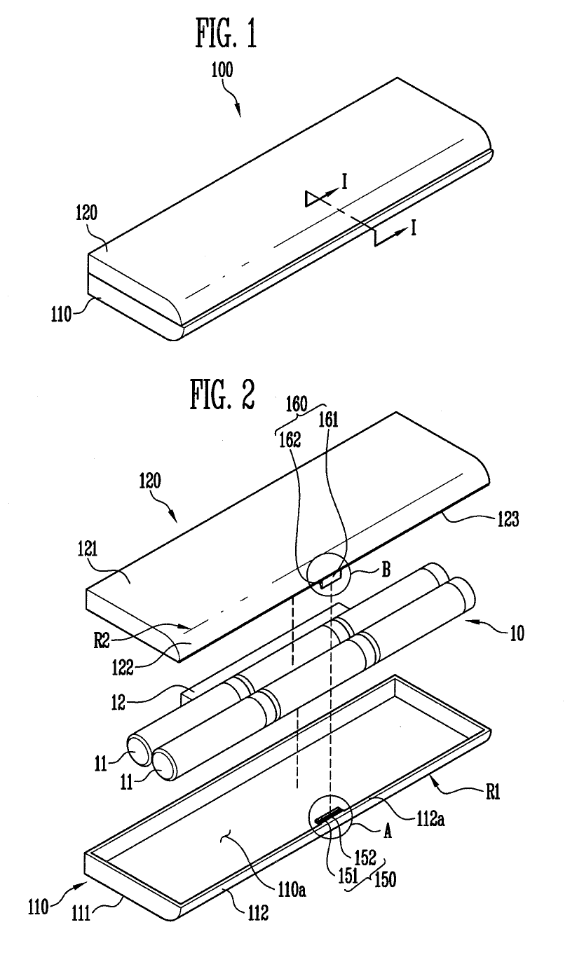

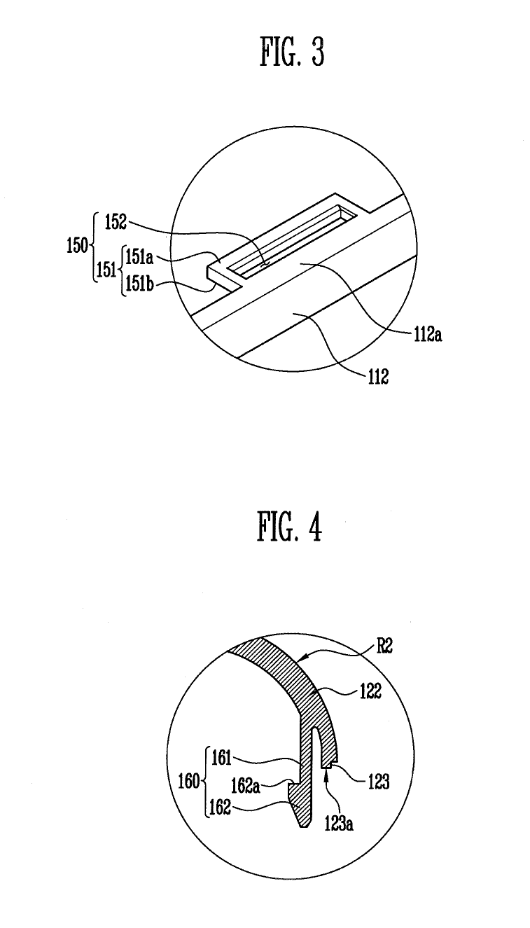

FIG. 1 is a perspective view of a battery case according to an embodiment of the present invention. FIG. 2 is an exploded perspective view of the battery case of FIG. 1.

The battery case 100 according to this embodiment includes a first case 110 configured to have a first side portion 112 surrounding an internal space 110a, the first case 110 having a first fastening portion 150 extended from an end portion 112a of the first side portion 112; and a second case 120 configured to have a second side portion 122 corresponding to the first side portion 112, the second case 120 having a second fastening portion 160 fastened to the first fastening portion 150. The first fastening portion 150 is shaped to extend toward the internal space 110a from the end portion 112a of the first side portion 112. The second fastening portion 160 is spaced apart from the second side portion 122 inside the second case 120 to extend toward the first fastening portion 150.

The battery case 100 includes the first and second battery cases 110 and 120 vertically separated from each other. The battery case 100 may be used as a housing accommodating a core pack 10 therein. The core pack 10 may include a protective circuit module 12 configured to control bare cells 11 connected in series or parallel. For example, the bare cell 11 may be a lithium secondary battery which can be reversibly charged/discharged. The battery case 100 accommodates the lithium secondary battery, thereby implementing a battery pack. The battery pack may be used as a power source of an external electronic device such as a notebook computer or cellular phone.

The battery case 100 may include the first case 110 configured to have the first fastening portion 150, and the second case 120 configured to have the second fastening portion 160 fastened to the first fastening portion 150. The first case 110 may include a first base portion 111 and a first side portion 112 connected to surround the internal space 110a at the outer circumference of the first base portion 111. The second case 120 may include a second base portion 121 configured to face the first base portion 111, and a second side portion 122 extended from the outer circumference of the second base portion 121 to face the first base portion 111. The aforementioned bare cells 11 and the like may be accommodated in the internal space provided by the first base portion 111 and the first side portion 112 and the internal space provided by the second base portion 121 and the second side portion 122. At least one portion of the first side portion 112 may be connected to the base portion 111 to have a curved surface portion R1, and at least one portion of the second side portion 122 may be connected to the second base portion 121 to have a curved surface portion R2.

Generally, a battery case should be formed in various shapes according to external appearances of bare cells or electronic devices in which the battery case is employed. In this case, the productivity and external appearance of the battery case may be problematic. The battery case is formed by injecting a resin, using a mold. In this case, a portion at which the resin is not filled in the mold frequently occurs according to the shape of the battery case. As such, the portion at which the resin is not filled in the mold causes an external appearance failure and lowers the strength of the battery case. In addition, a stress mark or the like occurs in the outer surface of the battery case after the injection, and a subsequent process is added to remove a stain caused by the stress mark. This lowers the productivity of the battery case and increases the unit cost of the battery case.

The battery case according to embodiments of the present invention has first and second fastening portions with a new structure. The battery case including the first and second fastening portions and a side portion having a curved surface portion may be manufactured by injection molding. In this case, an external appearance failure caused by a stress mark or the like does not occur in the outer surface of the battery case. Thus, when the battery case is manufactured, the productivity of the battery case is improved by preventing the occurrence of a failure, and it is unnecessary to add a subsequent process for removing a stain, thereby improving process efficiency.

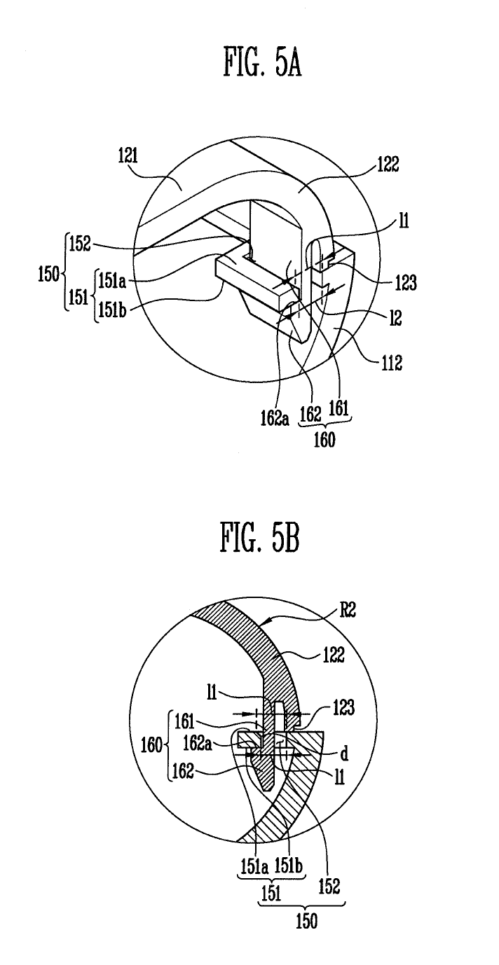

FIG. 3 is an enlarged view of portion A of FIG. 2. FIG. 4 is an enlarged view of portion B of FIG. 2.

Referring to FIGS. 3 and 4, the first fastening portion 150 is extended from the end portion 112a of the first side portion 112, and may include a plate 151 configured to have a fastening hole 152 formed therein. The second fastening portion 160 may be fastened to the first fastening portion 150 by being inserted into the fastening hole 152 of the first fastening portion 150. For example, the section of the connecting portion between the first fastening portion 150 and the first side portion 112 may be formed in a square or ‘ [symbol] ’ shape. The first fastening portion 150 and the first side portion 112 may be integrally formed by injection.

The second fastening portion 160 may include an extending portion 161 extended from an inside of the second side portion 122, and a fastening projection 162 protruded from an end of the extending portion 161 in the opposite direction to the second side portion 122. The fastening projection 162 may be fastened to the first fastening portion 150 by being inserted into the fastening hole 152. The fastening projection 162 is connected to protrude from the extending portion 161. In this case, the fastening projection 162 may have a portion 162a vertically connected to the extending portion 161. For example, the fastening projection 162 is provided so that the width of the fastening projection 162 is narrowed as the fastening projection 162 approaches the end of the extending portion 161. In this case, the section of the fastening projection 162 may be formed in a triangular shape.

The second fastening portion 160 may be provided perpendicular to the second base portion 121 at the curved surface portion R2 of the second side portion 122. The second side portion 122 may be connected to the second base portion 121 to have the curved surface portion R2. Thus, the second fastening portion 160 can be spaced apart from at least one portion of the second side portion 122 to be parallel to the portion of the second side portion 122.

The second fastening portion 160 and the second side portion 122 may be integrally formed by injection, using one mold. In this case, the second fastening portion 160 and the second side portion 122 are provided in parallel, and therefore, an approximately vertically bent portion in which contraction and stress occur does not exist in the mold. Thus, when a resin is filled in the mold, there occurs an area in which the resin is incompletely filled or not filled in the mold, and accordingly, it is possible to prevent contraction caused by the density difference of the resin. Further, a stress mark, e.g., a stain or the like, does not occur, and accordingly, it is unnecessary to add a subsequent process for removing the stain.

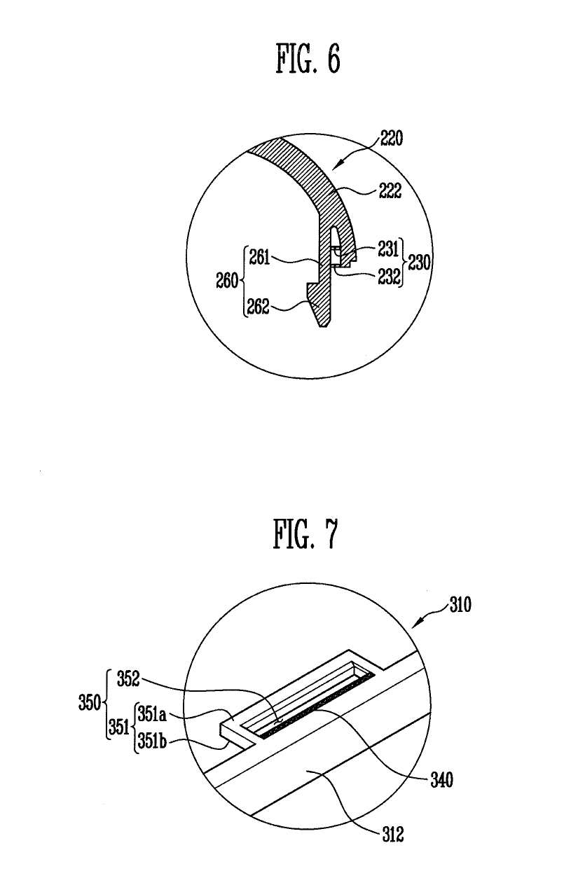

FIG. 5A is a perspective sectional view taken along line I-I of FIG. 1. FIG. 5B is a sectional view taken along line I-I of FIG. 1.

FIGS. 5A and 5B are views showing a state in which the first and second fastening portions 150 and 160 are fastened to each other. The fastening projection 162 of the second fastening portion 160 is inserted into the fastening hole 152 of the first fastening portion 150, so that the first and second fastening portions 150 and 160 can be hook-coupled to each other. In this case, the fastening hole 152 is provided to pass from a first surface 151a of the plate 151 facing the second side portion 122 to a second surface 151b that is the opposite surface of the first surface 151 of the plate 151. In this case, the size l1 of the fastening hole 152 provided in the first surface 151a of the plate 151 may be formed greater than that l2 of the fastening hole 152 provided in the second surface 151b of the plate 151. For example, the section of the fastening hole 152 may be provided to the greatest size in the first surface 151a of the plate 151 so that the size of the fastening hole 152 is decreased to a predetermined depth d toward the second surface 151b, and is equal from the predetermined depth d to the second surface 151b of the plate 151. That is, the section of the fastening hole 152 may be formed in a trapezoid shape from the first surface 151a of the plate 151 to the predetermined depth d, and may be formed in the shape of a quadrangular shape from the predetermined depth d to the second surface 151b of the plate 151.

After the fastening projection 162 is inserted into the fastening hole 152, a vertical portion 162a that is a portion vertically connected to the extending portion 161 from the fastening projection 162 may be overlapped with the second surface 151b of the plate 151. The size of the fastening hole 152 in the first surface 151a of the plate 151 is provided relatively greater (than that of the fastening hole 152 in the second surface 151b of the plate 151), and thus the fastening projection 162 can be easily inserted into the fastening hole 152 of the plate 151. Further, the vertical portion 162a of the fastening projection 162 is overlapped with the second surface 151b of the plate 151, and thus the fastening projection 162 and the fastening hole 152 can be firmly fixed.

The second side portion 122 may have a stepped portion 123 provided at the end thereof. The stepped portion 123 may be recessed inward from the outer surface of the second side portion 122. An end 123a of the stepped portion 123 may be mounted on the plate 151. The stepped portion 123 guides the degree where the fastening projection 162 is inserted into the fastening hole 152, so that it is possible to prevent deformation of the external appearance, caused by a strong external force.

Hereinafter, other embodiments of the present invention will be described with reference to FIGS. 6 to 8. Contents of these embodiments, except the following contents, are similar to those of the embodiment described with reference to FIGS. 1 to 5B, and therefore, their detailed descriptions will be omitted.

FIG. 6 is a sectional view showing a second fastening portion according to another embodiment of the present invention.

Referring to FIG. 6, a second case 220 may include a second side portion 222, and a second fastening portion 260 provided in parallel to the side portion 222 at a curved surface portion of the second side portion 222. The second fastening portion 260 may be provided to be spaced apart from the second side portion 222.

One or more ribs 230 connecting the second fastening portion 260 and the second side portion 222 may be provided between the second fastening portion 260 and the second side portion 222. The rib 230 may be provided perpendicular to the second fastening portion 260. The second fastening portion 260 may be provided to have a thickness relatively thinner than that of the second side portion 222. The rib 230 connects the second fastening portion 260 to the second side portion 222, thereby firmly fixing the second fastening portion 260 to the second side portion 222.

The rib 230 may include first and second ribs 231 and 232. The first rib 231 may be provided adjacent to an approximately central portion in the inside between the second fastening portion 260 and the second side portion 222, and the second rib 232 may be provided to connect the end of the second side portion 222 to the second fastening portion 260. The first and second ribs 231 and 232 are provided between the second fastening portion 260 and the second side portion 222, so that the thickness of the rib 230 can be decreased. Further, the rib 230 can connect the second fastening portion 260 and the second side portion 222 to have high strength.

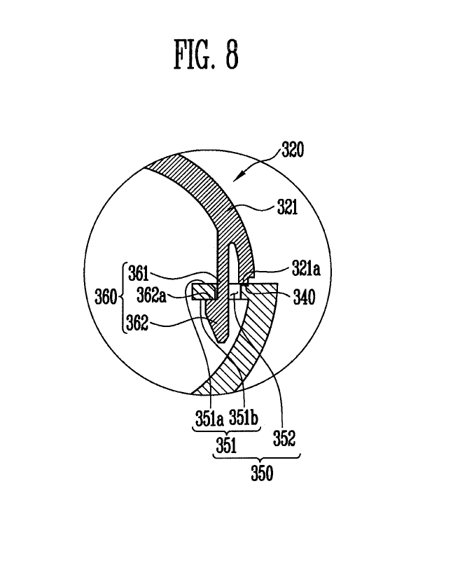

FIG. 7 is a perspective view showing a first fastening portion according to still another embodiment of the present invention. FIG. 8 is a sectional view showing the first fastening portion and a second fastening portion according to the embodiment of the present invention.

Referring to FIGS. 7 and 8, a first case 310 may include a first side portion 312 and a first fastening portion 350 vertically connected to the first side portion 312. The first fastening portion 350 may include a plate 351 configured to have first and second surfaces 351a and 351b, a fastening hole 352 provided inside the plate 351, and a mounting portion 340 provided outward from the fastening hole 352 in the plate 351. A second case 320 may include a second side portion 321 and a second fastening portion 360 provided inward from the second side portion 321 to be spaced apart from the second side portion 321.

The first fastening portion 350 of the first case 310 is fastened to the second fastening portion 360 of the second case 320. In this case, the first fastening portion 350 may further have the mounting portion 340 on which an end 321a of the second side portion 322 is mounted. The mounting portion 340 is provided in the first surface 351a of the plate 351 facing the second side portion 321. For example, the mounting portion 340 may have a surface contour corresponding to that of the end 321a of the second side portion 321. The surface contour or roughness is formed rougher than that of peripheral portions, so that it is possible to increase the friction between the second side portion 321 and the mounting portion 340. Thus, when the second side portion 321 is mounted on the mounting portion 340, a problem of slipping or the like does not occur, and the fastening between the first and second fastening portions 350 and 360 can be easily performed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery case, comprising:
a first case having a first side portion with an end portion surrounding an internal space thereof, the first case having a first fastening portion extended from the end portion of the first side portion; and
a second case having a second side portion corresponding to the first side portion, the second case having a second fastening portion fastened to the first fastening portion,
wherein the first fastening portion is bent to extend toward the internal space from the end portion of the side portion, and the second fastening portion is spaced apart from the second side portion inside the second case to extend toward the first fastening portion.

2. The battery case of claim 1, wherein the first fastening portion includes a plate extended from the end portion of the first side portion, wherein a fastening hole is provided inside the plate.

3. The battery case of claim 2, wherein the fastening hole is provided to pass from a first surface of the plate facing the second side portion to a second surface that is the opposite surface of the first surface of the plate, and the size of the fastening hole provided in the first surface of the plate is formed greater than that of the fastening hole provided in the second surface of the plate.

4. The battery case of claim 2, wherein the second fastening portion is fastened to the first fastening portion by being inserted into the fastening hole of the first fastening portion.

5. The battery case of claim 4, wherein the second fastening portion includes an extending portion extended from an inside of the second side portion, and a fastening projection protruded from an end of the extending portion in the opposite direction to the second side portion.

6. The battery case of claim 5, wherein the fastening projection is inserted into the fastening hole, and has a portion vertically connected to the extending portion.

7. The battery case of claim 2, wherein a stepped portion recessed inward from an outer surface of the second side portion is provided at an end of the second side portion.

8. The battery case of claim 7, wherein an end of the stepped portion is mounted on the plate.

9. The battery case of claim 1, wherein the first case includes a first base portion and a first side portion connected to surround the internal space at the outer circumference of the first base portion, and the second case includes a second base portion configured to face the first base portion, and a second side portion extended from the outer circumference of the second base portion to face the first base portion, and
wherein at least one portion of the first side portion is connected to the first base portion to have a curved surface portion, and at least one portion of the second side portion is connected to the second base portion to have a curved surface portion.

10. The battery case of claim 9, wherein the second fastening portion is provided perpendicular to the second base portion at the curved surface portion of the second side portion.

11. The battery case of claim 2, wherein one or more ribs connecting the second fastening portion and the second side portion are provided between the second fastening portion and the second side portion.

12. The battery case of claim 11, wherein the rib is provided perpendicular to the second fastening portion.

13. The battery case of claim 2, wherein the first fastening portion is further provided with a mounting portion on which the end of the second side portion is mounted.

14. The battery case of claim 13, wherein the mounting portion is provided in the first surface of the plate facing the second side portion, and has surface roughness corresponding to that of the end of the second side portion.

15. A battery case comprising:
a first case having a first base portion and first side portion that extends substantially perpendicular to the first base portion wherein the first case defines an internal space, wherein the first case includes a first fastening portion that extends into the internal space from the first side portion and defines an opening;
a second case having a second base portion and a side portion that extends substantially perpendicular to the second base portion wherein the second case defines an internal space that, combined with the internal space of the first case, defines a space that is dimensioned to receive one or more batteries, wherein the second case further includes a second fastening portion that extends substantially parallel to the second side portion and engages with the first fastening portion so as to secure the first and second cases together.

16. The battery case of claim 15, wherein the first and second side portions are curved and wherein the second fastening portion extends in a direction that is substantially parallel to the curved portion of the second side portion.

17. The battery case of claim 15, wherein the first fastening portion defines an opening that receives the second fastening portion so as to secure the first and second cases together.

18. The battery case of claim 17, wherein the first fastening portion comprises a plate having a first surface and a second surface, and wherein the opening is formed in the plate and wherein the opening has a greater dimension adjacent the first surface of the plate than the opening at the second surface of the plate.

19. The battery case of claim 18, wherein the second fastening portion includes an extending portion that extends from an inside of the second side portion and a fastening projection protruding an end of the extending portion in a substantially perpendicular direction to the second side portion.

20. The battery case of claim 15, wherein ribs are formed between the second fastening portion and the second side portion.
